(19) United States
(12) Patent Application Publication
(10) Pub. No.: US 2025/0085417 A1
(43) Pub. Date: Mar. 13, 2025

(54) RADAR SENSOR APPARATUS FOR VEHICLE AND CONTROL METHOD THEREOF

(71) Applicant: HYUNDAI MOBIS CO., LTD., Seoul (KR)

(72) Inventor: Nam Hyung KIM, Yongin-si (KR)

(73) Assignee: HYUNDAI MOBIS CO., LTD., Seoul (KR)

(21) Appl. No.: 18/675,603

(22) Filed: May 28, 2024

(30) Foreign Application Priority Data
Sep. 11, 2023 (KR) 10-2023-0120499

(51) Int. Cl. G01S 13/931

(52) U.S. Cl. CPC G01S 13/931

(57) ABSTRACT

A radar sensor apparatus for a vehicle includes a sensor device including a plurality of radar sensors, each of which detects a surrounding target by irradiating a radar signal based on a beam pattern, and a control device that controls the plurality of radar sensors by adjusting an application ratio of a high-resolution mode based on a short range, and a long-range mode depending on a change in a state and surrounding environment of a vehicle.

### CROSS-REFERENCE TO RELATED APPLICATION

This application claims the benefit of priority to Korean Patent Application No. 10-2023-0120499, filed in the Korean Intellectual Property Office on Sep. 11, 2023, the entire contents of which are incorporated herein by reference.

### TECHNICAL FIELD

The present disclosure relates to a radar sensor apparatus for a vehicle that controls a radar sensor by selecting an optimal mode for improving the performance of the radar sensor depending on vehicle states and surrounding environments, and a control method thereof.

### BACKGROUND

Radar is a device that radiates electromagnetic wave signals through a transmitting antenna (referred to as a “Tx antenna”), receives the signal reflected from a target from a receiving antenna (referred to as an “Rx antenna”), and generates detection information such as the distance, speed, and angle of the target by using the received signal.

A radar technology is used to detect the target in an in-vehicle driving assistance system, to provide a warning of accident risks for detected targets in advance, and to actively prevent and avoid the accident risks.

The performance of a radar sensor for a vehicle may vary depending on an array structure of an antenna and an operating method of a lamp.

The radar sensors for a vehicle may be broadly classified into front radar and side radar. The front radar and the side radar may adjust the direction and shape of beams radiated by the array structure of the antenna.

Moreover, the radar sensors for a vehicle may be classified into long-range detection and short-range detection depending on the operation method. In this case, high-resolution imaging radar may be configured by adjusting the resolution according to a detection distance through the adjustment of an operating method and sampling of the radar sensor. However, the characteristics of the radar sensors for a vehicle may vary significantly depending on an antenna beam pattern and an operating method.

To this end, in the past, a radar mode is changed to a long-range mode and a short-range mode by changing a beam pattern of the antenna through antenna array control. This method changes an antenna gain for each angle, and refers to a method that adjusts the maximum detectable distance by changing the power radiated at each angle.

However, as such, a method of changing a beam pattern of an antenna requires controlling a plurality of antennas to change the beam pattern, and thus it is difficult to configure a virtual array through multiple-input and multiple-output (MIMO), and it may be difficult to improve the angular resolution in an azimuth angle, which may limit radar performance.

### SUMMARY

The present disclosure has been made to solve the above-mentioned problems occurring in the related art while advantages achieved by the prior art are maintained intact.

An aspect of the present disclosure provides a radar sensor apparatus for a vehicle that may maintain high angular resolution by maximizing the number of virtual arrays of antennas by using a beam pattern fixed to an antenna of a radar sensor, and a control method thereof.

An aspect of the present disclosure provides a radar sensor apparatus for a vehicle that may improve the performance of a radar sensor by adjusting an application ratio of a high-resolution mode based on a short range and a long-range mode depending on vehicle states and surrounding environments, and a control method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a radar sensor apparatus for a vehicle includes a sensor device including a plurality of radar sensors, each of which detects a surrounding target by irradiating a radar signal based on a beam pattern, and a control device that controls the plurality of radar sensors by adjusting an application ratio of (i) a first mode based on a short range, and (ii) a second mode depending on a change in a state and surrounding environment of the vehicle.

In an embodiment, each of the plurality of radar sensors includes a number of virtual arrays, each of the virtual arrays corresponds to a receiving channel, and the number of virtual arrays is based on the beam pattern and obtained by multiplying a number of transmitting antennas and a number of receiving antennas.

In an embodiment, the control device determines a mode operating level of each of the plurality of radar sensors depending on a speed of the vehicle and whether a target is detected in a specific area around the vehicle and adjusts the application ratio of the first mode and the second mode in response to the determined mode operating level under a predetermined condition.

In an embodiment, the mode operating level of each of the plurality of radar sensors is classified into (i) a level 0 at which the second mode is exclusively operated, (ii) a level 1 at which the second mode is mainly reflected and the first mode is partially reflected, (iii) a level 2 at which the second mode and the first mode are complexly reflected and operated, (iv) a level 3 at which the first mode is mainly reflected and the second mode is partially reflected, and (v) a level 4 at which the first mode is exclusively operated.

In an embodiment, the control device further sets the mode operating level of each of the plurality of radar sensors to the level 0 when a short-range target is not detected in a short-range area that is farther than a first distance and is within a second distance from the vehicle, sets the mode operating level of each of the plurality of radar sensors to the level 1 when a number of the short-range targets is smaller than or equal to a first predetermined number and is detected in the short-range area, sets the mode operating level of each of the plurality of radar sensors to the level 2 when a plurality of short-range targets are detected in the short-range area, sets the mode operating level of each of the plurality of radar sensors to the level 3 when a speed of the vehicle is smaller than a reference speed and a number of ultra-short-range targets is smaller than or equal to a predetermined number and is detected in an ultra-short-range area within the first distance from the vehicle, and sets the mode operating level of each of the plurality of radar sensors to the level 4 when the speed of the vehicle is smaller than a reference speed and the ultra-short-range targets are detected in the ultra-short-range area.

In an embodiment, the control device further operates a mode of each of the plurality of radar sensors in units of frame, and determines a mode to be applied to each frame based on the application ratio, which is set in response to the mode operating level.

In an embodiment, the control device further switches the mode of each of the plurality of radar sensors to the first mode or the second mode by adjusting a signal bandwidth of each of the plurality of radar sensors.

In an embodiment, the control device further sets a maximum detection distance of each of the plurality of radar sensors by adjusting a number of samplings based on distance resolution of the first mode or the second mode.

In an embodiment, the control device further sets a maximum detection speed of each of the plurality of radar sensors by adjusting a chirp time for a frequency signal of each of the plurality of radar sensors, and sets speed resolution of each of the plurality of radar sensors based on an operating time of the frame according to the chirp time and a number of chirps.

According to an aspect of the present disclosure, a method of controlling a radar sensor apparatus for a vehicle includes detecting, by a plurality of radar sensors, a surrounding target by irradiating a radar signal based on a beam pattern from the plurality of radar sensors, and controlling, by a control device, the plurality of radar sensors by adjusting an application ratio of a first mode based on a short range, and a second mode depending on a change in a state and surrounding environment of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram showing a configuration of a radar sensor apparatus for a vehicle, according to an embodiment of the present disclosure;

FIG. 2 is a diagram showing a configuration of a radar sensor, according to an embodiment of the present disclosure;

FIGS. 3 and 4 are diagrams showing a basic operation of a radar sensor, according to an embodiment of the present disclosure;

FIGS. 5 and 6 are diagrams showing an operation of adjusting angular resolution of a radar sensor, according to an embodiment of the present disclosure;

FIG. 7 is a diagram showing a radar sensor mode, according to an embodiment of the present disclosure;

FIGS. 8A and 8B are diagrams illustrating an operation of changing a radar sensor mode, according to an embodiment of the present disclosure;

FIGS. 9A and 9B are diagrams showing an operation of adjusting a detection distance of a radar sensor, according to an embodiment of the present disclosure;

FIG. 10A is a diagram showing an operation of adjusting a maximum detection speed of a radar sensor, according to an embodiment of the present disclosure;

FIG. 10B is a diagram showing an operation of adjusting speed resolution of a radar sensor, according to an embodiment of the present disclosure;

FIGS. 11A and 11B are diagrams showing a control operation of a radar sensor mode, according to an embodiment of the present disclosure;

FIGS. 12A to 12C are diagrams illustrating an application example of a radar sensor mode, according to an embodiment of the present disclosure; and

FIG. 13 is a diagram illustrating an operation flow of a method for controlling a radar sensor apparatus for a vehicle, according to an embodiment of the present disclosure.

### DETAILED DESCRIPTION

Hereinafter, some embodiments of the present disclosure will be described in detail with reference to the accompanying drawings. In adding reference numerals to components of each drawing, it should be noted that the same components have the same reference numerals, although they are indicated on another drawing. In describing embodiments of the present disclosure, detailed descriptions associated with well-known functions or configurations will be omitted when they may make subject matters of the present disclosure unnecessarily obscure.

In describing components of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning that is consistent with their meaning in the context of the present disclosure and the relevant art and will not be interpreted in an idealized or overly formal sense unless expressly so defined herein.

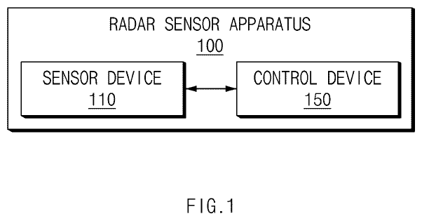

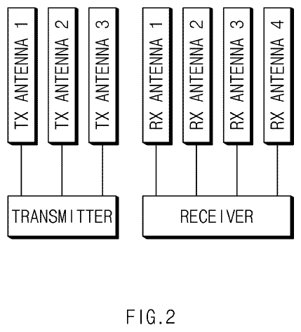

FIG. 1 is a diagram showing a configuration of a radar sensor apparatus for a vehicle, according to an embodiment of the present disclosure. FIG. 2 is a diagram showing a configuration of a radar sensor, according to an embodiment of the present disclosure.

Referring to FIG. 1, a radar sensor apparatus 100 for a vehicle may include a sensor device 110 and a control device 150.

The sensor device 110 may include a plurality of radar sensors. Here, the plurality of radar sensors may include a front radar sensor and a side radar sensor.

The front radar sensor may be a sensor that detects an object in front of a vehicle, and long-range radar (LRR) may be applied as the front radar sensor to detect an object in front located at a long distance.

The side radar sensor may be a sensor that detects the object located in a side direction of the vehicle, and short-range radar (SRR) may be applied as the side radar sensor to detect a wide range of the object located at a short distance. For example, the side radar sensor may be installed on a front left, a front right, a rear left, and a rear right.

Each of the front radar sensor and the side radar sensor may include a transmitter and a receiver, as shown in FIG. 2. In this case, the transmitter may be connected to a plurality of Tx antennas, and the receiver may be connected to a plurality of Rx antennas.

Here, the Tx antennas connected to the transmitter of the radar sensor and the Rx antennas connected to the receiver of the radar sensor may be installed to have a fixed beam pattern depending on the type (e.g., LRR or SRR) of a radar sensor.

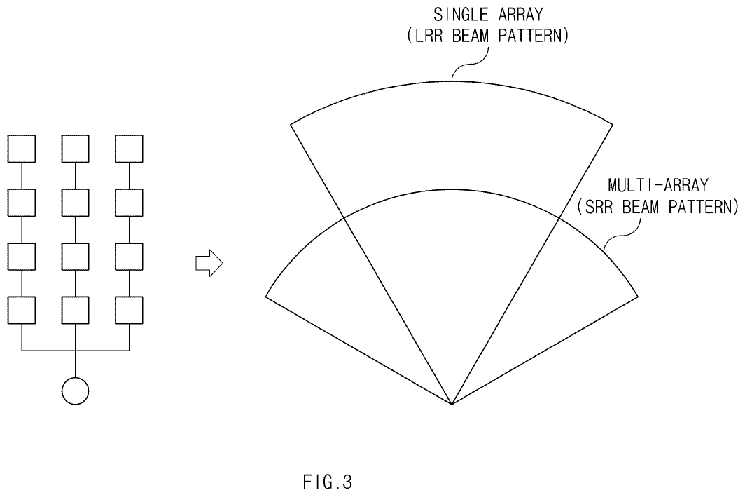

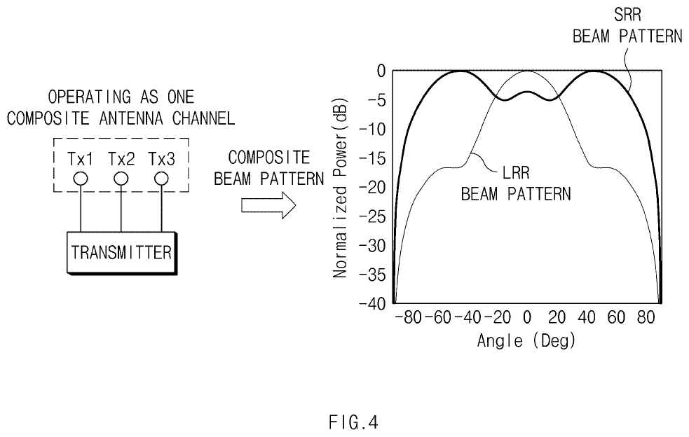

FIGS. 3 and 4 are diagrams showing a basic operation of a radar sensor, according to an embodiment of the present disclosure.

First of all, FIG. 3 is a diagram showing a fixed beam pattern of a radar sensor, according to an embodiment of the present disclosure. As shown in FIG. 3, the long-range radar LRR may have a fixed beam pattern in a narrow and long shape by arranging Tx/Rx antennas in a single array. Furthermore, the short-range radar SRR may have a fixed beam pattern in a wide and short shape by arranging Tx/Rx antennas in a multi-array.

Here, locations of Tx antennas and Rx antennas may be arranged to have optimal field of view (FoV) and angle identification ability in a direction of an azimuth angle and/or elevation angle through an MIMO operation.

At this time, the radar sensor mode may be changed by combining channels of antennas of the radar sensor and modifying the beam pattern of the antennas.

FIG. 4 shows an embodiment of modifying a beam pattern of a Tx antenna through channel synthesis of the Tx antenna. As shown in FIG. 4, when the beam pattern of the antenna is modified through channel synthesis of the Tx antenna, the number of Tx channels is substantially reduced. As the number of effective channels increases, the angular resolution of a radar sensor increases. Because the number of antenna virtual arrays and the total length of a virtual array are reduced when the number of Tx channels is reduced through channel synthesis of Tx antennas, the angular resolution may be reduced, thereby limiting radar performance.

Accordingly, the radar sensor according to an embodiment of the present disclosure may expand the effective Rx channel by maintaining a fixed beam pattern of an antenna and increasing the number of virtual arrays and the total length (width) of the virtual array through MIMO, thereby ensuring high angular resolution.

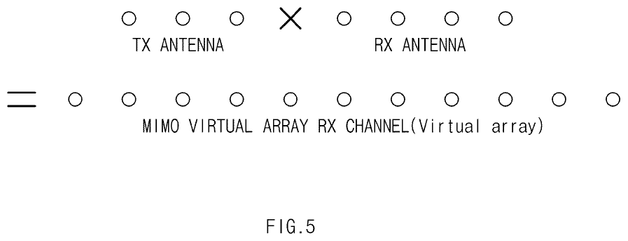

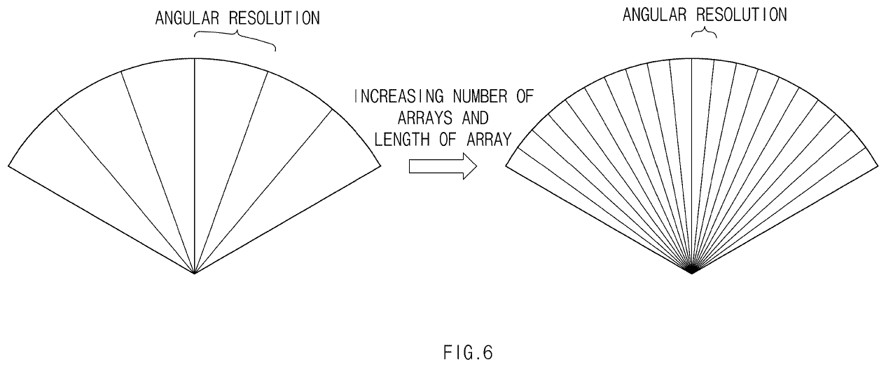

FIGS. 5 and 6 are diagrams showing an operation of adjusting angular resolution of a radar sensor, according to an embodiment of the present disclosure.

Referring to FIG. 5, antennas through MIMO may secure the number of virtual arrays corresponding to Rx channels as many as the number obtained by multiplying the number of Tx antennas and the number of Rx antennas.

As such, when a virtual array is formed while a Tx antenna and an Rx antenna of a radar sensor are fixed, the number of virtual arrays and the total length of a virtual array may be maximally secured. When the number of virtual arrays and the total length of a virtual array increase, higher angular resolution may be secured as shown in FIG. 6.

The control device 150 may perform overall functions for operating the radar sensor apparatus 100 for a vehicle according to an embodiment of the present disclosure. Here, the control device 150 may be implemented in a form of an independent hardware device including a memory and at least one processor for processing each operation and may be driven in a form included in other hardware devices such as a microprocessor or a general purpose computer system. The at least one processor may be implemented as an application specific integrated circuit (ASIC), a central processing unit (CPU), a microcontroller, and/or a microprocessor.

The control device 150 may monitor vehicle state information and surrounding environment information and may change a radar sensor mode depending on changes in vehicle states and surrounding environments, thereby improving the detection performance of a radar sensor. For example, the control device 150 may secure high distance resolution by changing a mode by adjusting an operating method of the radar sensor.

In this case, the control device 150 may monitor the surrounding environmental information based on detection information from the radar sensor, but is not limited thereto. In other words, the control device 150 may also monitor surrounding environmental information based on data from other sensors such as a camera, a LiDAR, or the like in addition to the radar.

Furthermore, the control device 150 may receive the vehicle state information from a system for managing a vehicle state or at least one sensor and may monitor changes in vehicle states based on the received vehicle state information.

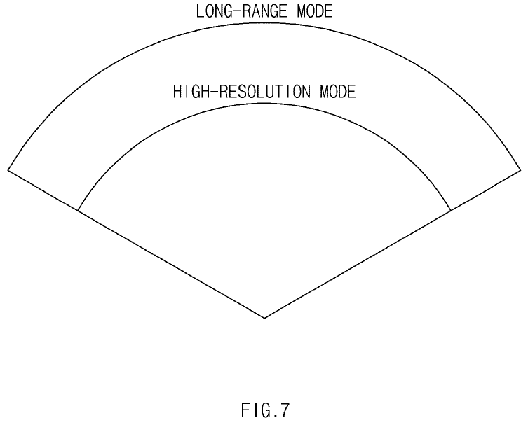

FIG. 7 is a diagram showing a radar sensor mode, according to an embodiment of the present disclosure.

As shown in FIG. 7, a radar sensor mode may include a long-range mode and a high-resolution mode. The long-range mode and the high-resolution mode may be classified based on each radar sensor without distinguishing between LRR/SRR In this case, each of the long-range mode and the high-resolution mode may be applied by changing a maximum detection distance, a maximum detection speed, and speed resolution in a fixed antenna beam pattern.

For example, the control device 150 may change the radar sensor mode according to the detection distance by adjusting a signal bandwidth of the radar sensor.

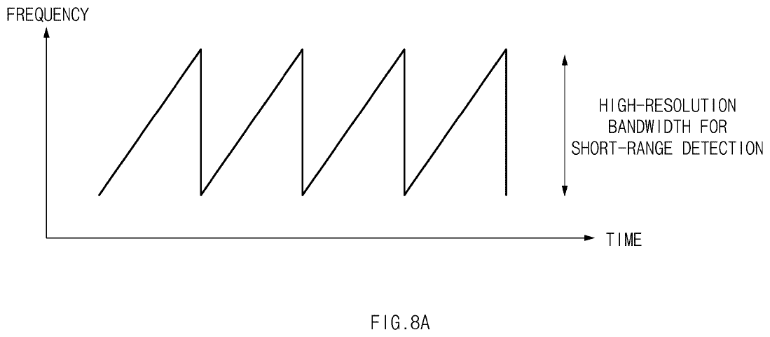

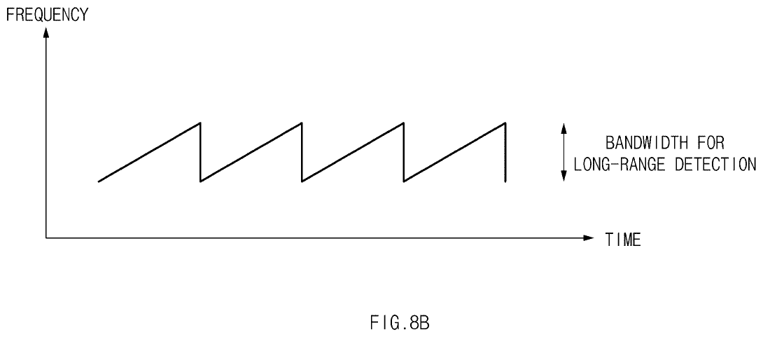

FIGS. 8A and 8B are diagrams illustrating an operation of changing a radar sensor mode, according to an embodiment of the present disclosure.

Referring to FIGS. 8A and 8B, when a signal bandwidth of a radar sensor is changed, distance resolution changes in proportion to the signal bandwidth.

For example, as illustrated in FIG. 8A, when the signal bandwidth of a radar increases, a target located at the close distance may be identified as the distance resolution increases. Accordingly, when short-range detection is required based on vehicle states and/or surrounding situations, the control device 150 may change the radar sensor mode to a high-resolution mode by increasing the signal bandwidth of the radar sensor.

In the meantime, as illustrated in FIG. 8B, when the radar's signal bandwidth is reduced, the capability of identifying an object is reduced as the distance resolution decreases. However, further distances may be identified based on the same number of samples. Accordingly, when long-range detection is required based on vehicle states and/or surrounding environments, the control device 150 may change the radar sensor mode to a long-range mode by decreasing the signal bandwidth of the radar sensor.

When the distance resolution of the radar sensor mode is determined, the control device 150 may adjust the detection distance of the radar sensor by adjusting the number of samples based on the determined distance resolution.

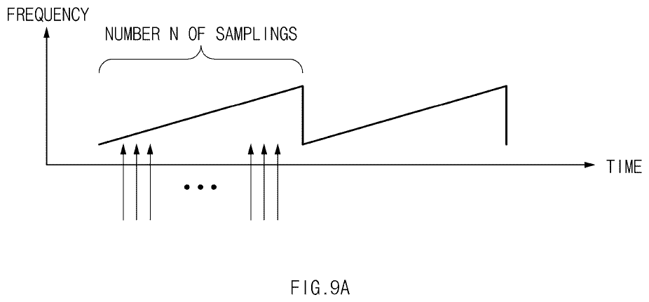

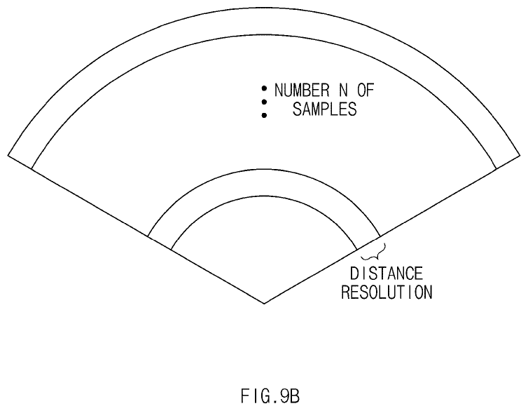

FIGS. 9A and 9B are diagrams showing an operation of adjusting a detection distance of a radar sensor, according to an embodiment of the present disclosure.

Referring to FIGS. 9A and 9B, when distance resolution is determined, the control device 150 may perform sampling at the determined distance resolution. When increasing the number of samples, the control device 150 may increase the maximum detection distance of the radar sensor as many as the increased number of samples. Accordingly, it is possible to set the maximum detection distance of the radar sensor depending on the number of samples. When the detection distance of the radar sensor increases, the performance of the radar sensor may also be improved.

As such, parameters for determining the performance of a radar sensor may include a chirp length, chirp duration, a chirp speed, and a frequency deviation in addition to the signal bandwidth and the number of samples.

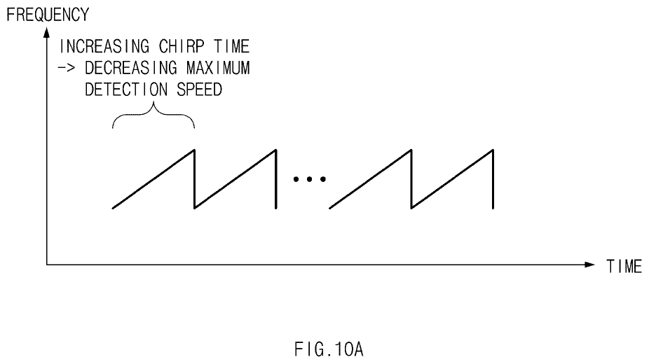

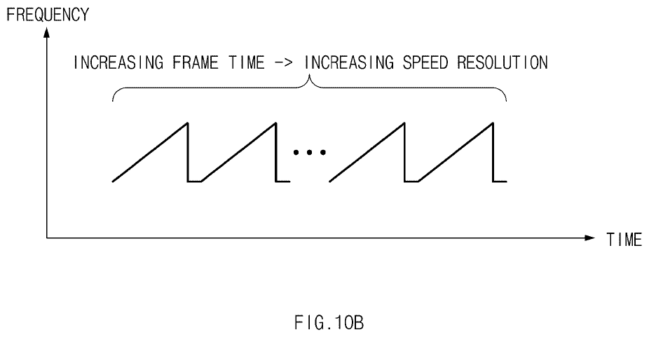

FIG. 10A is a diagram showing an operation of adjusting a maximum detection speed of a radar sensor according to a chirp time. FIG. 10B is a diagram showing an operation of adjusting speed resolution of a radar sensor according to a chirp frame operating time.

Referring to FIG. 10A, as the chirp time of a frequency signal increases, the maximum detection speed of a radar sensor decreases. Accordingly, the control device 150 may adjust the maximum detection speed of the radar sensor by adjusting each chirp time of the frequency signal.

Moreover, referring to FIG. 10B, each of a long-range mode and a high-resolution mode may operate on a frame basis. The operating time of each frame may vary depending on the chirp time and the number of chirps of the frequency signal. In this case, as the frame operating time increases, the speed resolution of the radar sensor increases. Accordingly, the control device 150 may adjust the frame operating time by adjusting the chirp time and the number of chirps, and thus may adjust the speed resolution of the radar sensor.

As such, in a long-range mode and/or a high-resolution mode, the control device 150 may improve the performance of the radar sensor by adjusting the maximum detection distance, the maximum detection speed, and the speed resolution.

When changing the radar sensor mode, the control device 150 may switch the radar sensor mode to one of the long-range mode or the high-resolution mode, or may also change the radar sensor mode to the combination of the long-range mode and the high-resolution mode.

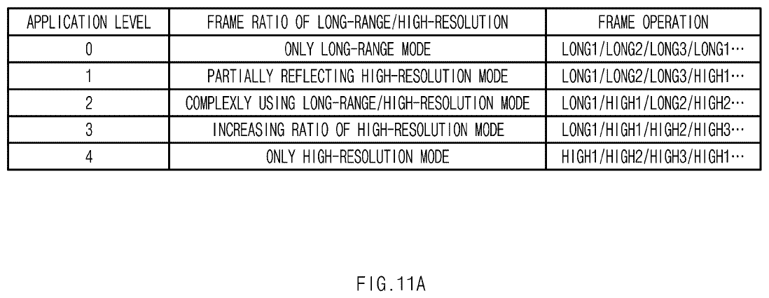

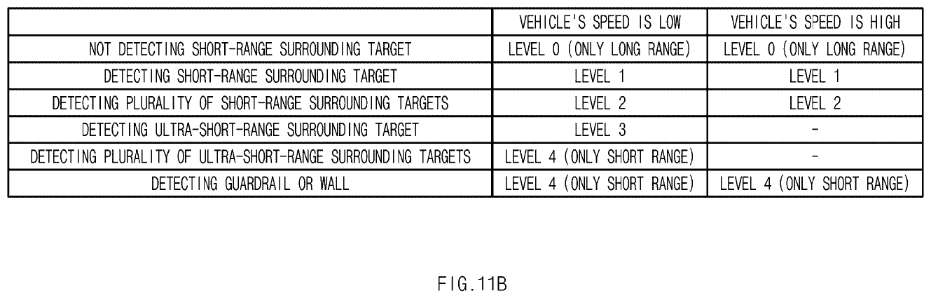

FIGS. 11A and 11B are diagrams showing a control operation of a radar sensor mode, according to an embodiment of the present disclosure.

The control device 150 may adjust an application ratio of a long-range mode and a high-resolution mode depending on a vehicle state and/or a surrounding environment. In this case, the application ratio of the long-range mode and the high-resolution mode may be adjusted on a frame basis.

Referring to FIG. 11A, the control device 150 may classify and apply application levels into levels 0 to 4 depending on the frame application ratio of the long-range mode and the high-resolution mode.

Level 0 may correspond to a mode operating stage where only the long-range mode is applied. In this case, “long1/long2/long3/long1 . . . ” may be applied to a frame.

In Level 1, the long-range mode may be mainly reflected. In other words, Level 1 may correspond to a mode operating stage where the high-resolution mode is partially reflected. In this case, “long1/long2/long3/high1 . . . ” may be applied to a frame.

Level 2 may correspond to a mode operating stage where the long-range mode and the high-resolution mode are complexly reflected. In this case, “long1/high1/long2/high2 . . . ” may be applied to a frame.

Level 3 may correspond to a mode operating stage where the proportion of the high-resolution mode increases and the long-range mode is partially reflected. In this case, “long1/high1/high2/high3 . . . ” may be applied to a frame.

Level 4 may correspond to a mode operating stage where only the high-resolution mode is applied. In this case, “high1/high2/high3/high1 . . . ” may be applied to a frame.

Referring to FIG. 11B, when a short-range surrounding target is not detected while a vehicle speed is low or high, the control device 150 may set the mode operating stage of the radar sensor mode to ‘level 0’. In this case, the radar sensor may detect surrounding targets while operating the frame at a ratio of ‘long1/long2/long3/long1 . . . ’. Here, the short-range surrounding target refers to a target located in a short-range area that is farther than the first distance and within the second distance from a vehicle.

Referring to FIG. 11B, when the short-range surrounding targets, of which the number is smaller than or equal to the specific number, are detected within a short-range area while the vehicle's speed is low or high, the control device 150 may set the mode operating stage of the radar sensor mode to ‘level 1’. In this case, the radar sensor may detect surrounding targets while operating the frame at a ratio of ‘long1/long2/long3/high1 . . . ’.

Furthermore, when a plurality of short-range surrounding targets are detected within a short-range area while the vehicle's speed is low or high, the control device 150 may set the mode operating stage of the radar sensor mode to ‘level 2’. In this case, the radar sensor may detect surrounding targets while operating the frame at a ratio of ‘long1/high1/long2/high2 . . . ’. Here, a state where the vehicle's speed is low means a state where the vehicle's speed is smaller than a predetermined lower reference speed, and a state where the vehicle's speed is high means a state where the vehicle's speed exceeds a predetermined upper reference speed. In this case, a range of the reference speed may be changed at any time.

When the short-range surrounding targets are detected in a state where the number of short-range surrounding targets is equal to the specific number while the vehicle's speed is low, the control device 150 may set the mode operating stage of the radar sensor mode to ‘level 3’. In this case, the radar sensor may detect ultra-short-range surrounding targets while operating the frame at a ratio of ‘long1/high1/high2/high3 . . . ’. Here, the ultra-short-range surrounding target refers to a target located in an ultra-short-range area within the first distance from the vehicle.

Besides, when a plurality of ultra-short-range surrounding targets are detected within an ultra-short-range area while the vehicle's speed is low, the control device 150 may set the mode operating stage of the radar sensor mode to ‘level 4’. In this case, the radar sensor may detect ultra-short-range surrounding targets while operating the frame at a ratio of ‘high1/high2/high3/high1 . . . ’.

In the meantime, when ultra-short range targets such as guardrails or walls (tunnels) are continuously detected, the control device 150 may set the mode operating stage of the radar sensor mode to ‘level 4’ regardless of whether the vehicle's speed is low or high. In this case, the radar sensor may detect ultra-short-range surrounding targets while operating the frame at a ratio of ‘high1/high2/high3/high1 . . . ’.

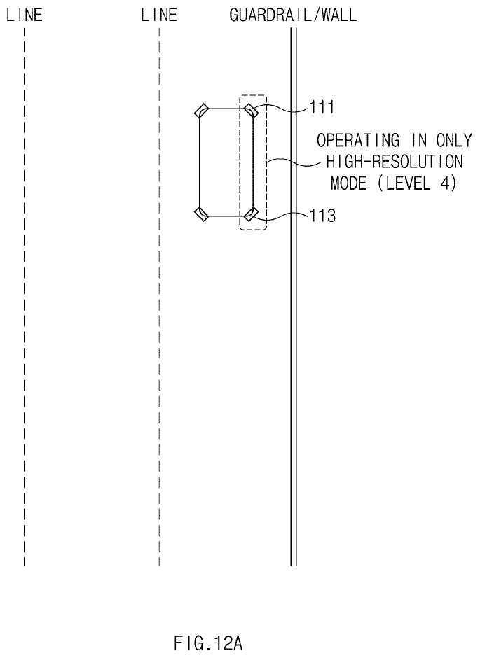

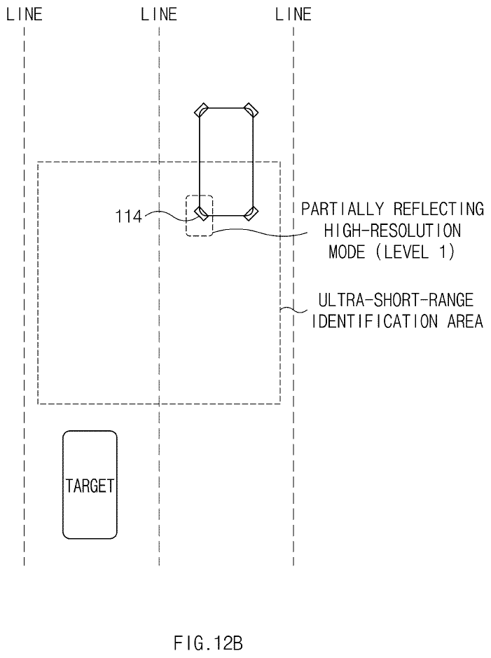

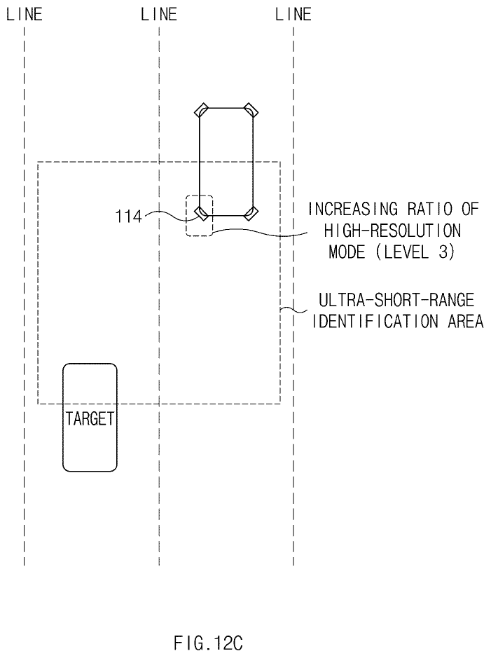

FIGS. 12A to 12C show an application example of a radar sensor mode, according to an embodiment of the present disclosure, and are diagrams illustrating control operations of a radar sensor mode according to a vehicle state and/or a surrounding environment.

Referring to FIG. 12A, it is shown that a guardrail or wall (tunnel) located at a very short distance to the right from a radar sensor (e.g., a first side radar sensor 111 and a second side radar sensor 113), which is located on the right side of the vehicle, is detected by identifying targets located at a very short distance or a short distance from the vehicle by using the vehicle's radar sensor.

As such, because there is no possibility of a target approaching the corresponding area when a guardrail or wall (tunnel) is present, there is no need to perform long-range detection.

Accordingly, the control device 150 may set a radar sensor mode to ‘level 4’ corresponding to a high-resolution mode and may adjust a maximum detection distance, a maximum detection speed, and speed resolution under the mode operating condition of level 4. Accordingly, the radar sensor may precisely detect short-range targets.

In this case, the control device 150 may allow the right side radar sensors 111 and 113 to operate in the high-resolution mode, and may allow a left side radar sensor to gradually increase an application ratio of the high-resolution mode depending on surrounding situations.

Referring to FIG. 12B, it is shown that a target located to be close to the left rear from a radar sensor (e.g., a third side radar sensor 114) located at the left rear of the vehicle is detected by identifying the target located at a very short distance or a short distance from the vehicle by using the vehicle's radar sensor.

In the embodiment of FIG. 12B, targets are detected at a short distance in a state where the number of targets is the specific number, and thus a situation where the targets is capable of being approached from a long distance needs to be considered.

Accordingly, the control device 150 may set a radar sensor mode to ‘level 1’, at which a high-resolution mode is partially reflected to a long-range mode, and may adjust a maximum detection distance, a maximum detection speed, and speed resolution under a mode operating condition of level 1.

Accordingly, the radar sensor may detect long-range and short-range targets by operating so as to apply a ratio of the long-range mode higher than a ratio of the high-resolution mode.

Referring to FIG. 12C, it is shown that a target located to be very close to the right rear from a radar sensor (e.g., a fourth side radar sensor 114) located at the right rear of the vehicle is detected by identifying the target located at a very short distance or a short distance from the vehicle by using the vehicle's radar sensor.

In the embodiment of FIG. 12C, the target is detected at a very short distance, and thus the detection proportion of short-range targets needs to be increased compared to the embodiment shown in FIG. 12B.

Accordingly, the control device 150 may set a radar sensor mode to ‘level 3’, at which the ratio of the high-resolution mode is increased, and may adjust a maximum detection distance, a maximum detection speed, and speed resolution under mode operating conditions of level 3.

Accordingly, the radar sensor of the vehicle may detect ultra-short-range and short-range targets by operating so as to apply a ratio of the high-resolution mode higher than a ratio of the long-range mode.

As such, when a target is present within a specific range around the vehicle, the control device 150 may gradually increase the proportion of the high-resolution mode and may increase the detection performance of a target located at a short distance.

When the vehicle's speed is slow and a plurality of targets are detected in a short range or ultra-short range, the control device 150 may operate in only the high-resolution mode by recognizing a section, in which roads are congested, or parking lots and then setting the radar sensor mode to level 4. As such, because the possibility that a target is approached at a high speed from a distance is low at a section, in which roads are congested, or parking lots, the optimal performance may be achieved by operating the radar to precisely detect short distances.

Although not shown in FIG. 1, the radar sensor apparatus 100 for a vehicle according to an embodiment of the present disclosure may further include a communication device and a storage device.

The communication device may include a communication module for vehicle network communication with automotive components and/or controllers included in a vehicle. Herein, the technology of the vehicle network communication may include Controller Area Network (CAN) communication, Local Interconnect Network (LIN) communication, Flex-Ray communication, or the like.

Moreover, the communication device may include a communication module for wireless Internet access or a communication module for short range communication. Herein, the wireless Internet technology may include Wireless LAN (WLAN), Wireless Broadband (Wibro), Wi-Fi, World Interoperability for Microwave Access (Wimax), or the like. Also, the technology of the short-range communication may include Bluetooth, ZigBee, Ultra Wideband (UWB), Radio Frequency Identification (RFID), Infrared Data Association (IrDA), or the like.

The storage may store data, commands, and/or algorithms necessary for the radar sensor apparatus 100 for a vehicle to operate. Herein, the storage device may include a storage medium such as a random access memory (RAM), a static random access memory (SRAM), a read-only memory (ROM), a programmable read-only memory (PROM), or an electrically erasable programmable read-only memory (EEPROM).

The operation flow of the radar sensor apparatus for a vehicle according to an embodiment of the present disclosure will be described in more detail as follows.

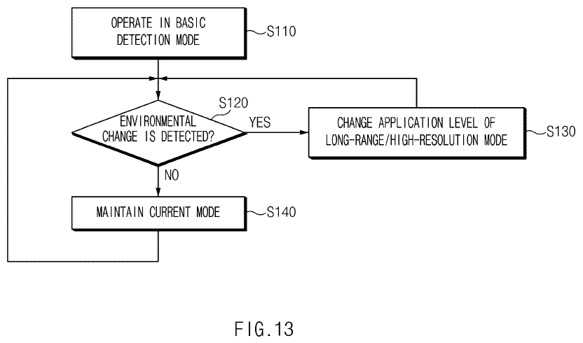

FIG. 13 is a diagram illustrating an operation flow of a method for controlling a radar sensor apparatus for a vehicle, according to an embodiment of the present disclosure.

Referring to FIG. 13, the radar sensor apparatus 100 for a vehicle according to an embodiment of the present disclosure allows a radar sensor to operate in a basic detection mode at the beginning of operation (S110).

While operating in the basic detection mode, the radar sensor apparatus 100 for a vehicle monitors a vehicle state and a surrounding environment in real time. When an environmental change in the vehicle state and/or the surrounding environment is detected (S120), the radar sensor apparatus 100 for a vehicle changes an application level of a long-range mode and a high-resolution mode based on changes in the vehicle state and/or the surrounding environment (S130). The radar sensor apparatus 100 for a vehicle operates radar by adjusting the application ratio of the long-range mode and/or the high-resolution mode based on the level changed in ‘S130’.

Here, as in the embodiment of FIG. 11B, the application level of the long-range mode and the high-resolution mode may be defined in advance, and may be set to the corresponding application level depending on the changes in the vehicle state and/or the surrounding environment. In this case, a radar operation method for each level may also be defined in advance as in the embodiment of FIG. 11A. However, the embodiments of FIGS. 11A and 11B are only examples and are not limited thereto. It is natural that they may be varied according to an embodiment.

‘S130’ may be performed whenever the environmental change in the vehicle state and/or the surrounding environment is detected.

In the meantime, when the environmental change is not detected in ‘S120’, the radar sensor apparatus 100 for a vehicle maintains the previously set mode and operates the radar (S140).

As described above, a radar sensor apparatus for a vehicle and a control method thereof according to an embodiment of the present disclosure may maintain high angular resolution by maximally adjusting the number of virtual arrays of antennas by using a beam pattern fixed to an antenna of a radar sensor and may adjust and operate an application ratio of a high-resolution mode based on a short range and a long-range mode depending on vehicle states and surrounding environments, thereby improving the performance of a radar sensor as both the detection distance and the detection speed are capable of being implemented.

The above description is merely an example of the technical idea of the present disclosure, and various modifications and modifications may be made by one skilled in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, high angular resolution may be maintained by adjusting the number of virtual arrays of antennas by using a beam pattern fixed to an antenna of a radar sensor.

Moreover, according to an embodiment of the present disclosure, the performance of a radar sensor may be improved by adjusting an application ratio of a high-resolution mode based on a short range and a long-range mode depending on vehicle states and surrounding environments.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A radar sensor apparatus for a vehicle, the apparatus comprising:
a sensor device including a plurality of radar sensors, each of which detects a surrounding target by irradiating a radar signal based on a beam pattern; and
a control device configured to control the plurality of radar sensors by adjusting an application ratio of (i) a first mode based on a short range, and (ii) a second mode depending on a change in a state and surrounding environment of the vehicle.

2. The apparatus of claim 1, wherein each of the plurality of radar sensors includes a number of virtual arrays, each of the virtual array corresponds to a receiving channel, and the number of virtual arrays is based on the beam pattern and obtained by multiplying a number of transmitting antennas and a number of receiving antennas.

3. The apparatus of claim 1, wherein the control device is configured to:
determine a mode operating level of each of the plurality of radar sensors depending on a speed of the vehicle, and whether a target is detected in a specific area around the vehicle; and
adjust the application ratio of the first mode and the second mode in response to the determined mode operating level under a predetermined condition.

4. The apparatus of claim 3, wherein the mode operating level of each of the plurality of radar sensors is classified into (i) a level 0 at which the second mode is exclusively operated, (ii) a level 1 at which the second mode is mainly reflected and the first mode is partially reflected, (iii) a level 2 at which the second mode and the first mode are complexly reflected and operated, (iv) a level 3 at which the first mode is mainly reflected and the second mode is partially reflected, and (v) a level 4 at which the first mode is exclusively operated.

5. The apparatus of claim 4, wherein the control device is further configured to:
set the mode operating level of each of the plurality of radar sensors to the level 0 when a short-range target is not detected in a short-range area that is farther than a first distance and is within a second distance from the vehicle;
set the mode operating level of each of the plurality of radar sensors to the level 1 when a number of the short-range targets is smaller than or equal to a first predetermined number and is detected in the short-range area;
set the mode operating level of each of the plurality of radar sensors to the level 2 when a plurality of short-range targets are detected in the short-range area;
set the mode operating level of each of the plurality of radar sensors to the level 3 when a speed of the vehicle is smaller than a reference speed and a number of ultra-short-range targets is smaller than or equal to a second predetermined number and is detected in an ultra-short-range area within the first distance from the vehicle; and
set the mode operating level of each of the plurality of radar sensors to the level 4 when the speed of the vehicle is smaller than a reference speed and the ultra-short-range targets are detected in the ultra-short-range area.

6. The apparatus of claim 5, wherein the control device is further configured to:
operate a mode of each of the plurality of radar sensors in units of frame, and
determine a mode to be applied to each frame based on the application ratio, which is set in response to the mode operating level.

7. The apparatus of claim 6, wherein the control device is further configured to:
switch the mode of each of the plurality of radar sensors to the first mode or the second mode by adjusting a signal bandwidth of each of the plurality of radar sensors.

8. The apparatus of claim 7, wherein the control device is further configured to:
set a maximum detection distance of each of the plurality of radar sensors by adjusting a number of samplings based on distance resolution of the first mode or the second mode.

9. The apparatus of claim 7, wherein the control device is further configured to:
set a maximum detection speed of each of the plurality of radar sensors by adjusting a chirp time for a frequency signal of each of the plurality of radar sensors; and
set speed resolution of each of the plurality of radar sensors based on an operating time of the frame according to the chirp time and a number of chirps.

10. A method of controlling a radar sensor apparatus for a vehicle, the method comprising:
detecting, by a plurality of radar sensors, a surrounding target by irradiating a radar signal based on a beam pattern from the plurality of radar sensors; and
controlling, by a control device, the plurality of radar sensors by adjusting an application ratio of a first mode based on a short range, and a second mode depending on a change in a state and surrounding environment of the vehicle.
